(19) United States
(12) Patent Application Publication
(10) Pub. No.: US 2025/0239667 A1
(43) Pub. Date: Jul. 24, 2025

(54) CHARGE/DISCHARGE INSPECTION DEVICE AND CHARGE/DISCHARGE INSPECTION METHOD

(71) Applicant: NIPPON STEEL TEXENG. CO., LTD., Tokyo (JP)

(72) Inventors: Tomoki HARAGUCHI, Tokyo (JP); Teruhito Ishibashi, Tokyo (JP)

(21) Appl. No.: 19/177,700

(22) Filed: Apr. 14, 2025

Related U.S. Application Data
(63) Continuation of application No. PCT/JP2023/029867, filed on Aug. 18, 2023.

(30) Foreign Application Priority Data
Nov. 30, 2022 (JP) 2022-191211

(51) Int. Cl. H01M 10/42; H01M 10/44

(52) U.S. Cl. CPC H01M 10/4285; H01M 10/4207; H01M 10/441

(57) ABSTRACT

Provided is a charge/discharge inspection device that brings charge/discharge contactors into contact with positive electrode terminals and negative electrode terminals of a plurality of secondary batteries arranged in a thickness direction and performs charging and discharging. The charge/discharge inspection device includes: a first movable mechanism that moves together a plurality of charge/discharge units having the charge/discharge contactors in a direction in which the plurality of secondary batteries are arranged; and a second movable mechanism that is provided independently of the first movable mechanism and individually moves the plurality of charge/discharge units in the direction in which the plurality of secondary batteries are arranged.

### CROSS-REFERENCE TO RELATED APPLICATIONS

This application is a Continuation Application of PCT application No. PCT/JP2023/029867 filed on Aug. 18, 2023, which is based upon and claims priority to Japanese Patent Application No. JP2022-191211 filed on Nov. 30, 2022, the disclosures of which are incorporated by reference.

### TECHNICAL FIELD

The present invention relates to a charge/discharge inspection device capable of charging/discharging a plurality of secondary batteries at one time, and particularly to a charge/discharge inspection device and a charge/discharge inspection method that make it possible to follow dimensional errors among secondary batteries, changes in shape during charging/discharging, and secondary batteries of different thickness types.

### BACKGROUND ART

In the charge/discharge inspection of secondary batteries, there have been known charge/discharge inspection devices that can charge/discharge a plurality of secondary batteries at one time. However, secondary batteries to be charged/discharged have variations in thickness due to their characteristics, so it is difficult to reliably bring charge/discharge contactors into contact with the secondary batteries. Further, it is more difficult to bring the charge/discharge contactors into contact with secondary batteries in a state where the plurality of secondary batteries are arranged in the thickness direction.

Therefore, there is a need for a charge/discharge inspection device that can reliably bring secondary batteries and charge/discharge contactors into contact with each other even in a state where the plurality of secondary batteries are arranged in the thickness direction. Such charge/discharge inspection devices (charge/discharge devices) include the one described in Patent Literature 1.

Patent Literature 1 describes a charge/discharge device in which a plurality of secondary batteries are arranged so as to be placed one over another in the thickness direction (the width direction), charge/discharge contactors (power supply side terminals) are brought into contact with (inserted into) the positive electrode terminals and the negative electrode terminals of the secondary batteries, and charging/discharging is performed.

This charge/discharge device includes, for the plurality of secondary batteries, a plurality of charge/discharge units having charge/discharge contactors (power supply side terminals) for each set of one or more secondary batteries, and the charge/discharge units are mounted slidably in the direction in which the secondary batteries are arranged.

### CITATION LIST

### Patent Literature

Patent Literature 1: Japanese Patent No. 5312000

### SUMMARY OF INVENTION

### Technical Problem

As described before, secondary batteries to be charged/discharged have variations in thickness due to their characteristics, so when a plurality of secondary batteries are arranged in the thickness direction, deviations (errors) in thickness are accumulated if the number of them is large. For example, even if each of the deviations in the thicknesses of the secondary batteries is a deviation of about 0.2 mm, the deviations are accumulated when the plurality of secondary batteries are arranged in the thickness direction, and for those located away from the reference position, it is difficult to connect the terminals of the secondary batteries and the charge/discharge contactors.

Then, since the charge/discharge device described in Patent Literature 1 has a mechanism that slides the charge/discharge contactors (the power supply side terminals 24) using only the tapered surfaces 35c of spacers 35 (FIGS. 1 and 3 in Patent Literature 1), the slide amounts of the charge/discharge contactors (the power supply side terminals 24), that is, variations in the thicknesses of secondary batteries and the number of secondary batteries that can be dealt with are determined only by the tapered surfaces 35c of the spacers 35. Therefore, the spacers inevitably need to be thick so as to be able to deal with large accumulated deviations, and as a result, the sizes of a tray receiving the secondary batteries and the charge/discharge device itself increase.

Therefore, the present invention provides a charge/discharge inspection device and a charge/discharge inspection method that make it possible to reliably bring secondary batteries and charge/discharge contactors into contact with each other even in a state where the plurality of secondary batteries are arranged in the thickness direction while suppressing an increase in the sizes of the tray and the device itself.

### Solution to Problem

A charge/discharge inspection device of the present invention is a charge/discharge inspection device that brings charge/discharge contactors into contact with positive electrode terminals and negative electrode terminals of a plurality of secondary batteries arranged in a thickness direction and performs charging and discharging, the charge/discharge inspection device comprising: a first movable mechanism that moves (slides) together a plurality of charge/discharge units having the charge/discharge contactors in a direction in which the plurality of secondary batteries are arranged; and a second movable mechanism that is provided independently of the first movable mechanism and individually moves (slides) the plurality of charge/discharge units in the direction in which the plurality of secondary batteries are arranged.

As a result, the first movable mechanism moves (slides) together the plurality of charge/discharge units in the direction in which the secondary batteries are arranged, and widens or narrows the pitch between the charge/discharge units according to the thickness of the secondary batteries to be inspected. In addition, the second movable mechanism individually moves (slides) each charge/discharge unit in the direction in which the secondary batteries are arranged, and moves (slides) the charge/discharge units according to the individual thicknesses of the secondary batteries to be inspected.

Further, it is desirable that in the charge/discharge inspection device, a first following tooth is provided for positioning the plurality of charge/discharge units with respect to the plurality of secondary batteries using the first movable mechanism.

By providing the first following tooth, it is possible to easily position the plurality of charge/discharge units that are moved together by the first movable mechanism in a simple configuration.

Further, it is desirable that in the charge/discharge inspection device, each of a plurality of second following teeth is provided for positioning the plurality of charge/discharge units with respect to the plurality of respective secondary batteries using the second movable mechanism.

By providing the plurality of second following teeth, it is possible to easily position each of the charge/discharge units that are moved individually by the second movable mechanism in a simple configuration.

Note that a charge/discharge inspection method of the present invention is a charge/discharge inspection method of bringing charge/discharge contactors into contact with positive electrode terminals and negative electrode terminals of a plurality of secondary batteries arranged in a thickness direction and performing charging and discharging, the charge/discharge inspection method comprising: a step of, by using a first movable mechanism, moving together a plurality of charge/discharge units having the charge/discharge contactors in a direction in which the plurality of secondary batteries are arranged; and a step of, by using a second movable mechanism provided independently of the first movable mechanism, individually moving the plurality of charge/discharge units in the direction in which the plurality of secondary batteries are arranged.

### Advantageous Effects of Invention

In the charge/discharge inspection device of the present invention, with such a configuration, the first movable mechanism moves (slides) together the plurality of charge/discharge units in the direction in which the secondary batteries are arranged and widens or narrows the pitch between the charge/discharge units according to the thickness of the secondary batteries to be inspected, so even when various types of secondary batteries having different thicknesses are inspected, it is possible to move (slide) together the plurality of charge/discharge units according to the thickness of the secondary batteries to be inspected. In addition, the second movable mechanism individually moves (slides) each charge/discharge unit in the direction in which the secondary batteries are arranged and moves (slides) the charge/discharge units according to the individual thicknesses of the secondary batteries to be inspected, so it is possible to absorb a deviation in thickness for each secondary battery even in the case of secondary batteries of the same type (secondary batteries having the same reference thickness) but individually having different thicknesses due to dimensional errors or changes in shape during charging/discharging.

Further, by providing the first following tooth and the second following teeth, the charge/discharge inspection device can easily position the charge/discharge units in a simple configuration.

Note that according to the charge/discharge inspection method of the present invention, the same operational effects as the charge/discharge inspection device of the present invention can be obtained.

### BRIEF DESCRIPTION OF DRAWINGS

FIG. 1 is a schematic configuration diagram showing a charge/discharge inspection device according to an embodiment of the present invention.

FIG. 2 is a schematic configuration diagram showing the charge/discharge inspection device according to the embodiment of the present invention.

FIG. 3 is a diagram showing a state in which a first movable mechanism of the charge/discharge inspection device shown in FIG. 1 has moved.

FIG. 4 is a schematic configuration diagram to the embodiment of the present invention.

FIG. 5 is a diagram showing a state in which the first movable mechanism of the charge/discharge inspection device shown in FIG. 4 has moved.

FIG. 6 is a diagram showing a state in which the first movable mechanism and a second movable mechanism of the charge/discharge inspection device shown in FIG. 4 have moved.

FIG. 7 is a schematic configuration diagram showing a charge/discharge inspection device according to another embodiment of the present invention.

FIG. 8 is a schematic configuration diagram showing a charge/discharge inspection device according to another embodiment of the present invention.

### DESCRIPTION OF EMBODIMENTS

Embodiments of the present invention will be described below in detail, but the description of the constituent features described below shows examples (representative examples) of embodiments of the present invention, and the present invention is not limited to the following content unless the spirit thereof is changed.

### [Charge/Discharge Inspection Device]

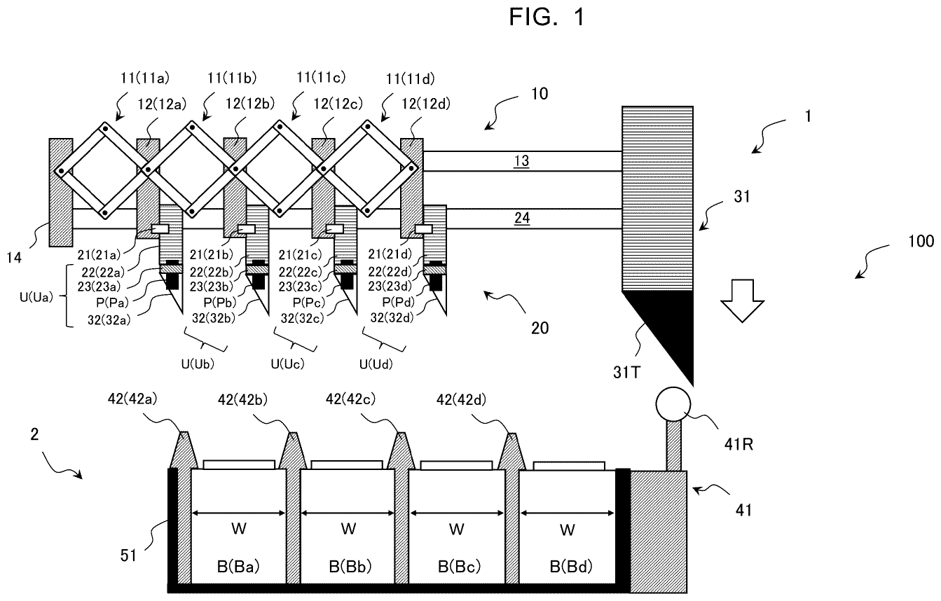

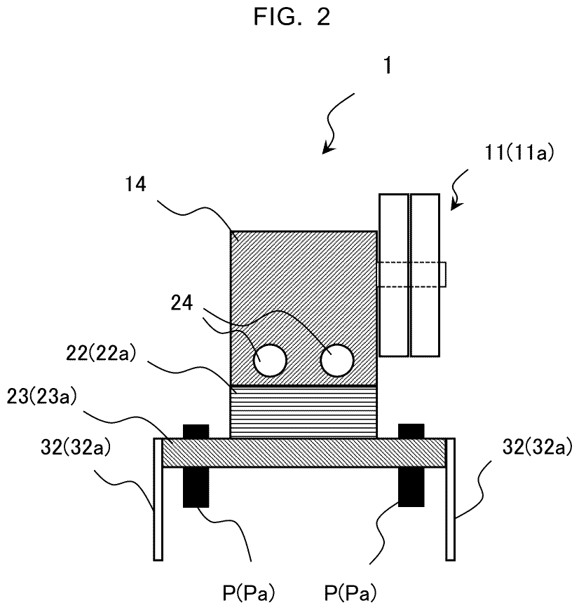

FIGS. 1 and 2 are schematic configuration diagrams showing a charge/discharge inspection device according to an embodiment of the present invention. Specifically, FIG. 1 is a side view showing the charge/discharge inspection device according to this embodiment at the time of charging, and FIG. 2 is its front view. That is, FIG. 2 is a diagram in which a charge/discharge jig 1 is viewed with a vertical board 14 in front.

A charge/discharge inspection device 100 is a charge/discharge inspection device that brings a plurality of charge/discharge contactors P into contact with positive electrode terminals and negative electrode terminals of a plurality of secondary batteries B arranged in the thickness direction (the width direction) and performs charging/discharging.

Further, the charge/discharge inspection device 100 is mainly divided into the charge/discharge jig 1 that has the charge/discharge contactors P and moves up and down via movable means (not shown) and a secondary battery side jig 2 including a tray 51 on which the plurality of secondary batteries B are arranged, separators 42 and the like. In this embodiment, four secondary batteries B (Ba-Bd) are arranged in the thickness direction on the tray 51. Note that in the example shown in FIG. 1, each of the thicknesses of the four secondary batteries B (Ba-Bd) is W.

The charge/discharge jig 1 has the plurality of charge/discharge contactors P (Pa-Pd) that come in contact with the positive electrode terminals and the negative electrode terminals of these four secondary batteries B (Ba-Bd). As shown in FIG. 2, the charge/discharge contactors Pa include a terminal that comes in contact with the positive electrode terminal of the secondary battery Ba and a terminal that comes in contact with the negative electrode terminal of the secondary battery Ba. The same applies to the charge/discharge contactors Pb-Pd.

Further, the charge/discharge jig 1 includes a first movable mechanism 10 that moves together a plurality of charge/discharge units U having the plurality of charge/discharge contactors P in the direction (the horizontal direction) in which the plurality of secondary batteries B are arranged and a second movable mechanism 20 that is provided independently of the first movable mechanism 10 and individually moves the plurality of charge/discharge units U having the plurality of charge/discharge contactors P in the direction in which the plurality of secondary batteries B are arranged.

### [First Movable Mechanism]

The first movable mechanism 10 includes the vertical board 14, a first following tooth 31, first mechanism parts 11 provided between the vertical board 14 and the first following tooth 31, support boards 12, and a support rod 13.

In this embodiment, the first mechanism parts 11 use a link mechanism. Specifically, the vertical board 14 and the support board 12a are connected by the first mechanism part 11a. Similarly, the support board 12a and the support board 12b are connected by the first mechanism part 11b, the support board 12b and the support board 12c are connected by the first mechanism part 11c, and the support board 12c and the support board 12d are connected by the first mechanism part 11d.

Further, the support board 12d and the first following tooth 31 are connected by the support rod 13. Since the charge/discharge jig 1 moves up and down via the movable means (not shown), the first following tooth 31 also moves up and down. Further, the first following tooth 31 moves horizontally via the first mechanism parts 11 as described later. On the other hand, the vertical board 14 moves up and down, but does not move horizontally.

### [Second Movable Mechanism]

The second movable mechanism 20 includes holding plates 22 connected to the support boards 12 via second mechanism parts 21. The holding plates 22 are provided slidably along support rods 24 provided between the vertical board 14 and the first following tooth 31. Note that two support rods 24 are provided on the near side and the far side as seen from FIG. 1 (see FIG. 2).

Further, as shown in FIGS. 1 and 2, terminal blocks 23 are fixed to the holding plates 22, and the terminal blocks 23 are provided with the charge/discharge contactors P and second following teeth 32. As used herein, a unit having a holding plate 22, a terminal block 23, charge/discharge contactors P, and second following teeth 32 is referred to as a charge/discharge unit U.

In this embodiment, in the second movable mechanism 20, the holding plates 22 (22a-22d) are connected to the respective support boards 12 (12a-12d) via the respective second mechanism parts 21 (21a-21d). Then, the terminal blocks 23 (23a-23d) are fixed to the respective holding plates 22 (22a-22d), and the terminal blocks 23 (23a-23d) are provided with the respective charge/discharge contactors P (Pa-Pd) and the respective second following teeth 32 (32a-32d). Note that as shown in FIG. 2, a second following tooth 32 is provided on each of the charge/discharge contactor Pa side that comes in contact with the positive electrode terminal of the secondary battery B and the charge/discharge contactor Pa side that comes in contact with the negative electrode terminal of the secondary battery B.

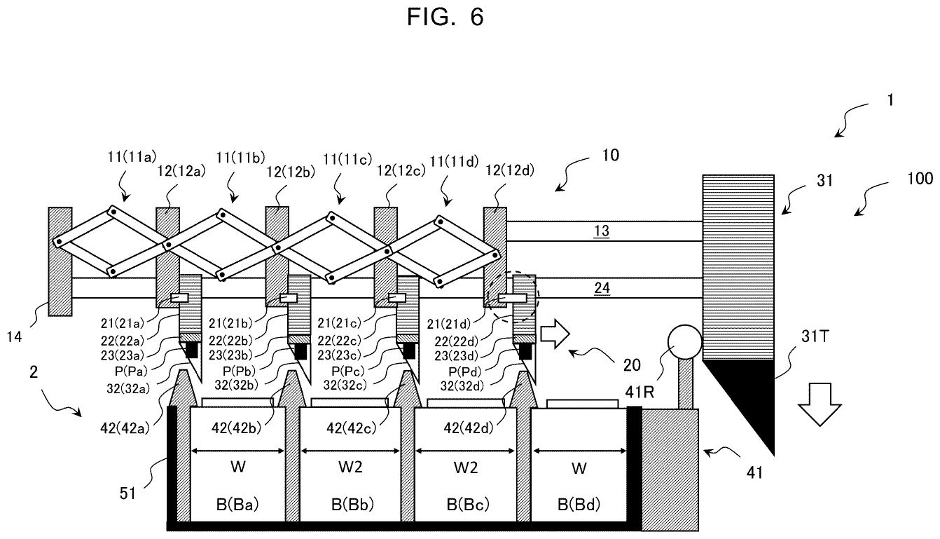

Elastic objects such as springs (coil springs) can be used for the second mechanism parts 21. The holding plates 22 are provided slidably along the support rods 24, and are connected to the support boards 12 via the second mechanism parts 21. Therefore, giving a description with reference to FIG. 6, when the charge/discharge jig 1 moves down and the second following teeth 32 (32d) touch the separator 42 (42d) and are pulled to the right (in the right arrow direction of FIG. 6), the second mechanism part 21 (21d) expands and the charge/discharge unit Ud having the charge/discharge contactors Pd moves to the right, that is, toward the position where the secondary battery Bd is located.

Conversely, when the charge/discharge jig 1 moves up and the contact between the second following teeth 32 and the separator 42 is released, the second mechanism part 21 (spring) contracts, and the holding plate 22 returns to its original position.

### [Secondary Battery]

As described before, four secondary batteries B (Ba-Bd) are arranged in the thickness direction on the tray 51. Further, a separator 42 is provided between secondary batteries B.

In this embodiment, a separator 42a is provided between the tray 51 and the secondary battery Ba, a separator 42b is provided between the secondary battery Ba and the secondary battery Bb, a separator 42c is provided between the secondary battery Bb and the secondary battery Bc, and a separator 42d is provided between the secondary battery Bc and the secondary battery Bd.

The separators 42 are for receiving the following teeth 32 of the charge/discharge inspection device 100, and in this embodiment, the separator 42a receives the following teeth 32a, the separator 42b receives the following teeth 32b, the separator 42c receives the following teeth 32c, and the separator 42d receives the following teeth 32d.

Further, a following tooth receiver 41 for receiving the following tooth 31 is provided on the secondary battery side. The following tooth receiver 41 has a roller 41R, and by causing a tip 31T of the following tooth 31 to touch the roller 41R, the following tooth 31 is received. The roller 41R is not particularly limited in shape as long as it can receive the following tooth 31, and may have a shape like the separators 42 shown in FIG. 1.

### [Operation of First Movable Mechanism]

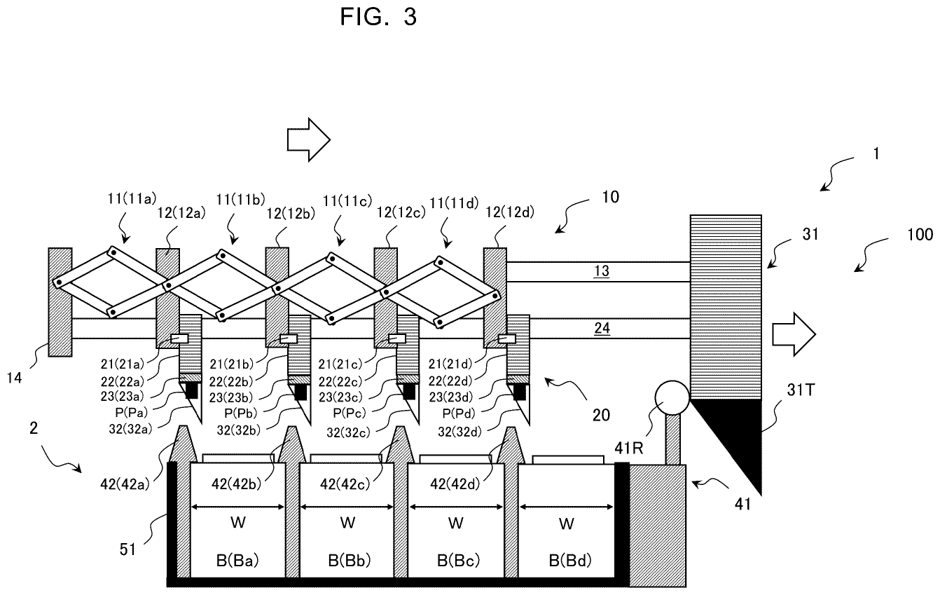

FIG. 3 is a diagram showing a state in which the first movable mechanism of the charge/discharge inspection device shown in FIG. 1 has moved.

When the charge/discharge jig 1 (the first following tooth 31) moves down from the state shown in FIG. 1, the tip 31T of the following tooth 31 touches the roller 41R of the following tooth receiver 41, and the first following tooth 31 moves in the direction in which the first mechanism parts 11 extend (the right arrow direction in FIG. 3).

Then, the first mechanism parts 11 connected via the support rod 13 extend to widen the intervals between the support boards 12 (12a-12d), and the charge/discharge units U having the holding plates 22 (22a-22d), the charge/discharge contactors P (Pa-Pd) and the like connected to the respective support boards 12 (12a-12d) move toward the respective positions where the secondary batteries B (Ba-Bd) that come in contact with the charge/discharge contactors P are located.

Then, when the first following tooth 31 further moves down, the charge/discharge contactors P (Pa-Pd) further approach the secondary batteries B (Ba-Bd), and finally the charge/discharge contactors P (Pa-Pd) come into contact with the respective secondary batteries B (Ba-Bd).

Note that the first mechanism parts 11 (the link mechanism) are provided with return springs (not shown). Therefore, when the contact between the secondary batteries B and the charge/discharge contactors P is released, the charge/discharge jig 1 (the first following tooth 31) moves up from the state shown in FIG. 3 to release the contact with the following tooth receiver 41, and the charge/discharge contactors P are pulled by the return springs to return to their original positions (the positions shown in FIG. 1).

### [Operation of Second Movable Mechanism]

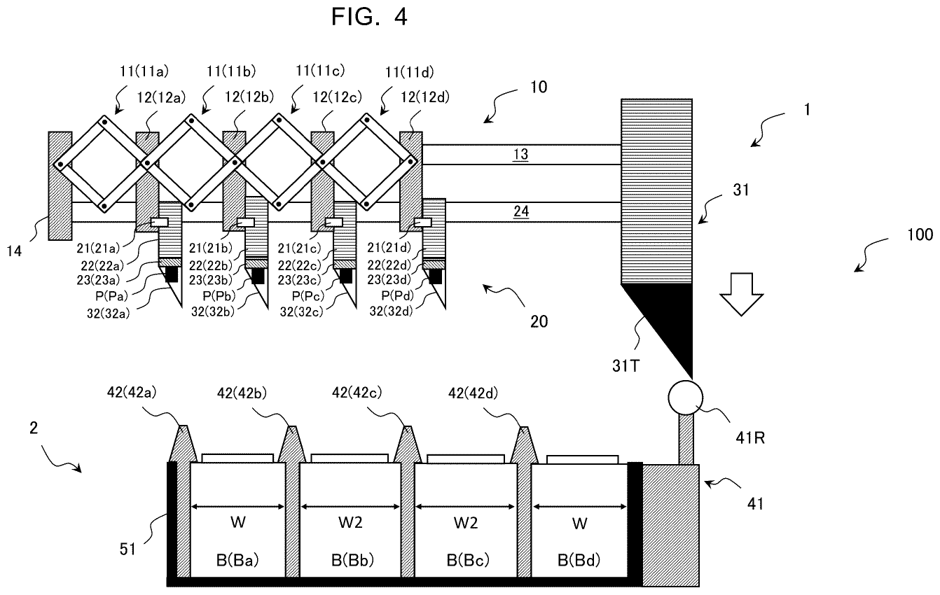

FIG. 4 is a schematic configuration diagram to the embodiment of the present invention.

Since the charge/discharge inspection device 100 shown in FIG. 4 has the same configuration as the charge/discharge inspection device 100 shown in FIG. 1, the same reference numeral is given and detailed description thereof is omitted.

On the other hand, in the example shown in FIG. 4, the thicknesses of the secondary batteries B arranged on the tray 51 are different between the secondary batteries Ba and Bd and the secondary batteries Bb and Bc. The thicknesses of the secondary batteries Bb and Bc are W2, which is thicker than the thicknesses W of the secondary batteries Ba and Bd.

Therefore, the deviations are accumulated as compared to the secondary batteries B shown in FIG. 1, and it becomes difficult to connect the charge/discharge contactors Pd and the secondary battery Bd at a position away from the reference position (the vertical board 14). For example, assuming that “W2=W+α”, the charge/discharge contactors Pd (the charge/discharge unit Ud) must be further moved toward the position where the secondary battery Bd is located by “2α” as compared to the example shown in FIG. 1.

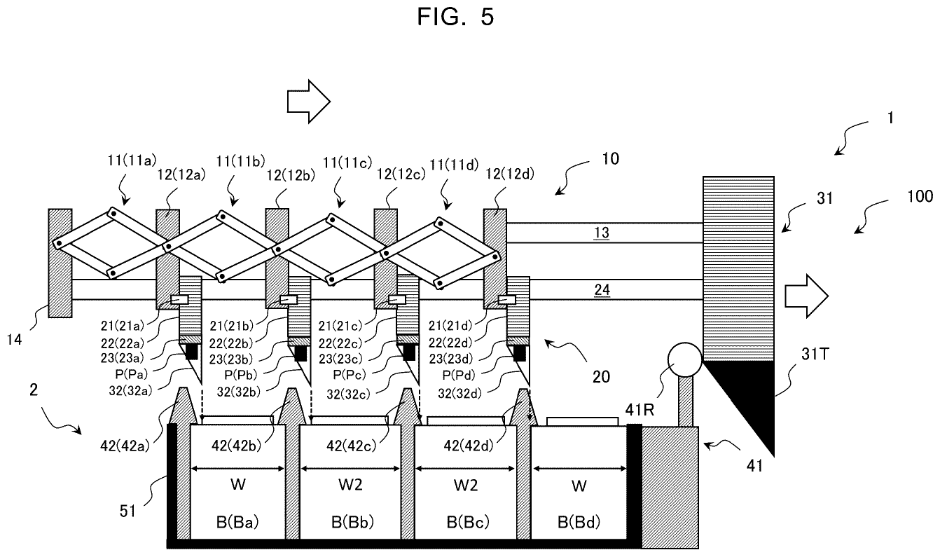

FIG. 5 is a diagram showing a state in which the first movable mechanism of the charge/discharge inspection device shown in FIG. 4 has moved. Further, FIG. 6 is a diagram showing a state in which the first movable mechanism and the second movable mechanism of the charge/discharge inspection device shown in FIG. 4 have moved.

When the first following tooth 31 moves vertically from the state shown in FIG. 4, the tip 31T of the following tooth 31 touches the roller 41R of a second following tooth receiver 41, and the first following tooth 31 moves in the direction in which the first mechanism parts 11 extend (the right arrow direction in FIG. 5).

Then, the first mechanism parts 11 connected via the support rod 13 extend to widen the intervals between the support boards 12 (12a-12d), and the holding plates 22 (22a-22d) and the charge/discharge contactors P (Pa-Pd) connected to the respective support boards 12 (12a-12d) move to the positions where the secondary batteries B (Ba-Bd) to be in contact are located, but as shown in FIG. 5, the charge/discharge contactors Pd must be further moved to the position where the secondary battery Bd is located by “2a”.

Here, when the first following tooth 31 further moves down from the state shown in FIG. 5, the second following teeth 32d touch the spacer 42d, and the second mechanism part 21d moves horizontally with respect to the support board 12d (see the right arrow in FIG. 6). Then, the charge/discharge unit Ud having the holding plate 22d, the charge/discharge contactors Pd and the like connected to the support board 12d via the second mechanism part 21d moves to the position where the secondary battery Bd to be in contact is located.

Thus, in the charge/discharge inspection device 100, even if the plurality of secondary batteries have variations in thickness and when they are arranged, the deviations are accumulated to form a large comb-like shape, the second movable mechanism 20 can absorb such deviations in thickness.

Note that in this embodiment, the deviations have been described using four secondary batteries B, but as the number of secondary batteries B increases, the deviations naturally increase. Then, the size (thickness) of the separators (following tooth receivers) inevitably increases so that they can deal with these large deviations, and the tray and the device itself increase in size. However, according to the charge/discharge inspection device 100 of the present invention, the plurality of moving mechanisms, which are the first movable mechanism 10 and the second movable mechanism 20, can absorb the deviations in the thicknesses of the secondary batteries B, and therefore such an increase in size can be prevented.

Furthermore, since the second movable mechanism 20 is provided independently of the first movable mechanism 10 and can individually move the plurality of charge/discharge contactors P (the plurality of charge/discharge units U), it can individually absorb the deviations in the thicknesses of the secondary batteries B, for example, even when the thicknesses of the plurality of secondary batteries B are not uniform at all, or even when each of the secondary batteries has swollen in charge/discharge inspections.

### Other Embodiments

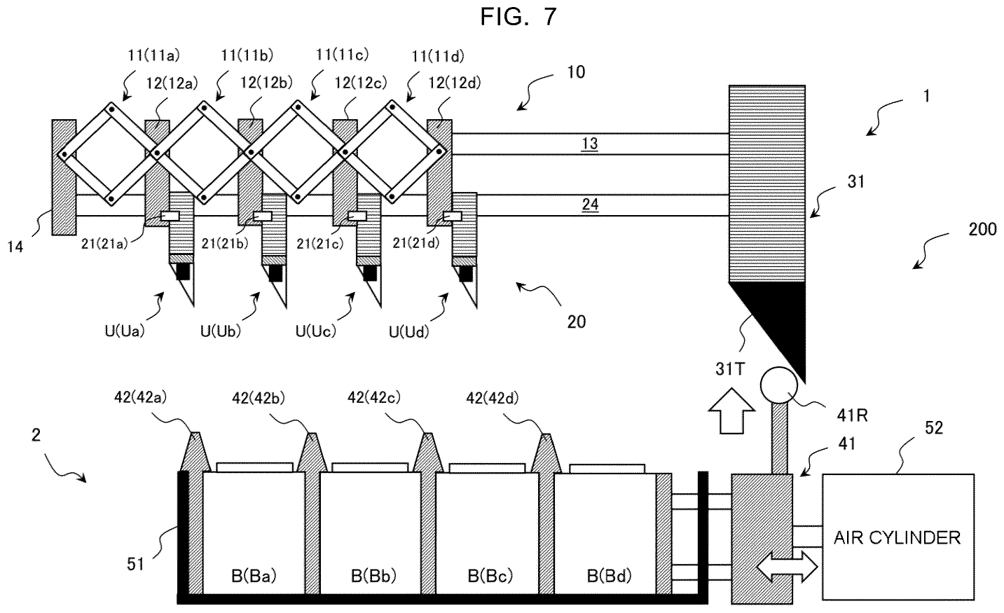

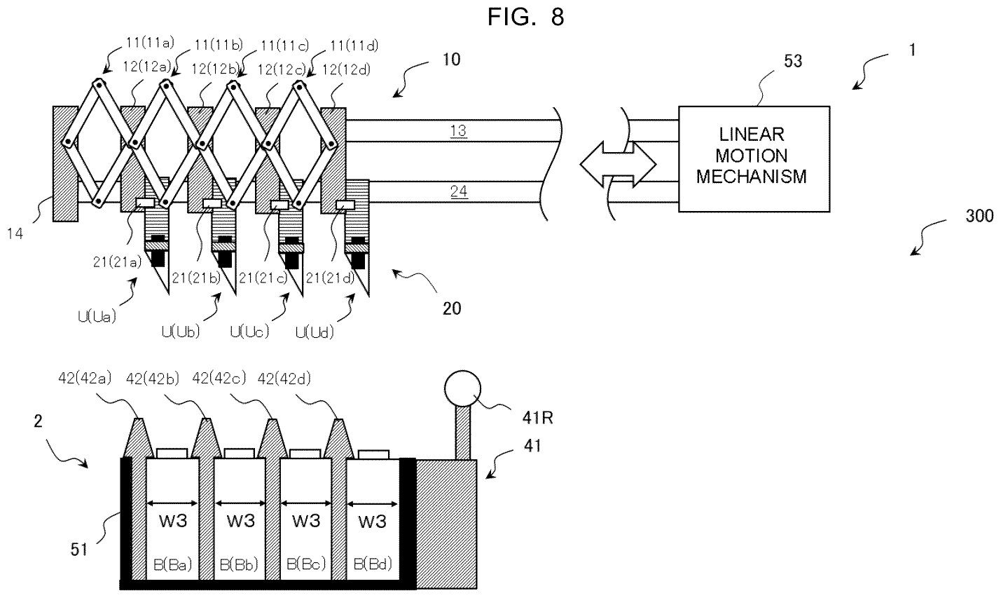

FIGS. 7 and 8 are schematic configuration diagrams showing charge/discharge inspection devices according to other embodiments of the present invention.

As shown in FIG. 7, in addition to the configuration of the charge/discharge inspection device 100, a charge/discharge inspection device 200 includes an air cylinder 52 that pressurizes the secondary batteries B arranged in the tray 51.

Further, the charge/discharge inspection device 200 can move up and down the roller 41R of the following tooth receiver 41 (move it in the vertical direction) via movable means (not shown). Therefore, in the examples shown in FIGS. 1-6, the charge/discharge jig 1 is moved down to cause the tip 31T of the first following tooth 31 to touch the roller 41R, but in the example shown in FIG. 7, the roller 41R can be moved vertically to cause the tip 31T of the first following tooth 31 to touch the roller 41R.

Thus, the configuration as shown in FIG. 7 can be used as a configuration for moving the plurality of charge/discharge contactors P (the plurality of charge/discharge units U) to the positions where the secondary batteries B are located.

Further, as shown in FIG. 8, in addition to the configuration of the charge/discharge inspection device 100, a charge/discharge inspection device 300 includes a linear motion mechanism 53 that performs control so that the first movable mechanism 10 moves in the direction in which the plurality of secondary batteries B are arranged (the arrow direction in FIG. 8). The linear motion mechanism 53 is composed of, for example, a servo motor and a ball screw. Of course, the linear motion mechanism 53 may be other than the configurations described before (a servo motor and a ball screw), and the first movable mechanism 10 may be moved manually.

Note that the type of secondary batteries B in the example shown in FIG. 8 is different from the type of secondary batteries B in the example shown in FIG. 1. That is, as can be seen by comparing the secondary batteries B shown in FIG. 1 with the secondary batteries B shown in FIG. 8, the respective thicknesses of the secondary batteries B (Ba-Bd) in the example shown in FIG. 8 are W3, and they are of a type thinner than the secondary batteries B in the example shown in FIG. 1.

In this way, when the secondary batteries B to be inspected are changed, the thickness of the secondary batteries B also changes significantly, so the first movable mechanism 10 can be moved by the linear motion mechanism 53 to change the pitch between the charge/discharge units U from the reference thickness (e.g., W) of the secondary batteries B before change to the reference thickness (e.g., W3) of the secondary batteries B after change.

Note that when the thickness error increases due to the accumulation of the deviations of the arranged secondary batteries B, it is possible to absorb the thickness error by moving the first movable mechanism 10 using the linear motion mechanism 53 and then further moving the first movable mechanism 10 using the first following tooth 31 (not shown in FIG. 8). On the other hand, since the thickness error may be small, the charge/discharge inspection device 300 can also be configured not to include the first following tooth 31.

Other than the above, the configurations of the charge/discharge inspection devices 100, 200, and 300 according to the present embodiments can be appropriately changed as long as the change does not deviate from the spirit of the present invention. For example, the upper and lower configurations of the charge/discharge jig 1 and the secondary battery side jig 2 can be reversed. In this case, the secondary battery side jig 2 is located above, the charge/discharge jig 1 is located below, and the charge/discharge jig 1 is moved up toward the secondary battery side jig 2 side.

### INDUSTRIAL APPLICABILITY

The present invention is useful in industry because it can be used in various situations as a charge/discharge inspection device and a charge/discharge inspection method that make it possible to reliably bring secondary batteries and charge/discharge contactors into contact with each other even in a state where the plurality of secondary batteries are arranged in the thickness direction while suppressing an increase in the sizes of the tray and the device itself.

### REFERENCE SIGNS LIST

1 charge/discharge jig
2 secondary battery side jig
10 first movable mechanism
11, 11a, 11b, 11c, 11d first mechanism part
12, 12a, 12b, 12c, 12d support board
13 support rod
14 vertical board
20 second movable mechanism
21, 21a, 21b, 21c, 21d second mechanism part
22, 22a, 22b, 22c, 22d holding plate
23, 23a, 23b, 23c, 23d terminal block
24 support rod
31 first following tooth
31T tip of first following tooth
32, 32a, 32b, 32c, 32d second following tooth
41 second following tooth receiver
41R roller
42, 42a, 42b, 42c, 42d separator
51 tray
52 air cylinder
53 linear motion mechanism
U, Ua, Ub, Uc, Ud charge/discharge unit
P, Pa, Pb, Pc, Pd charge/discharge contactor
B, Ba, Bb, Bc, Bd secondary battery
W, W2, W3 thickness of secondary battery
100, 200, 300 charge/discharge inspection device

1. A charge/discharge inspection device that brings charge/discharge contactors into contact with positive electrode terminals and negative electrode terminals of a plurality of secondary batteries arranged in a thickness direction and performs charging and discharging, the charge/discharge inspection device comprising:
a plurality of support boards arranged in a direction in which the plurality of secondary batteries are arranged;
a charge/discharge unit connected to one of the support boards and including a holding plate and one of the charge/discharge contactors held by the holding plate;
a first movable mechanism that moves together a plurality of the charge/discharge units in the same direction along the direction in which the plurality of secondary batteries are arranged; and
a second movable mechanism that is provided for each of the charge/discharge units and individually moves the plurality of charge/discharge units in the direction in which the plurality of secondary batteries are arranged.

2. The charge/discharge inspection device according to claim 1, wherein a first following tooth is provided for positioning the plurality of charge/discharge units with respect to the plurality of secondary batteries using the first movable mechanism, the first following tooth being connected to one of the support boards located at either end among the plurality of arranged support boards.

3. The charge/discharge inspection device according to claim 1, wherein a second following tooth provided for positioning the plurality of charge/discharge units with respect to the plurality of respective secondary batteries using the second movable mechanism is provided for each of the plurality of charge/discharge units.

4. A charge/discharge inspection method of bringing charge/discharge contactors into contact with positive electrode terminals and negative electrode terminals of a plurality of secondary batteries arranged in a thickness direction and performing charging and discharging in a charge/discharge inspection device comprising:
a plurality of support boards arranged in a direction in which the plurality of secondary batteries are arranged in the thickness direction; and
a charge/discharge unit connected to one of the plurality of support boards and including a holding plate and one of the charge/discharge contactors held by the holding plate,
the charge/discharge inspection method comprising:
a step of, by using a first movable mechanism, moving together a plurality of the charge/discharge units having the charge/discharge contactors in the same direction along the direction in which the plurality of secondary batteries are arranged; and
a step of, by using a second movable mechanism provided for each of the charge/discharge units, individually moving the plurality of charge/discharge units in the direction in which the plurality of secondary batteries are arranged.
